(19) United States
(12) Patent Application Publication
(10) Pub. No.: US 2008/0228912 A1
(43) Pub. Date: Sep. 18, 2008

(54) Enhanced Quality Reporting for Transmission Sessions

(76) Inventors: Ramakrishna Vedantham, Sunnyvale, CA (US); Imed Bouazizi, Tampere (FI); Igor Curcio, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/687,460

(22) Filed: Mar. 16, 2007

(51) Int. Cl. G06F 15/173

(52) U.S. Cl. 709/224

(57) ABSTRACT

This invention relates to methods, computer program products, clients, servers, systems and protocols in the context of reporting a quality of a transmission session according to one or more metrics, inter alia to adapt quality reporting to a switching of content within the transmission session and to allow faster session startup.

### FIELD OF THE INVENTION

This invention relates to methods, computer program products, clients, servers, systems and protocols in the context of reporting a quality of a transmission session according to one or more metrics.

### BACKGROUND OF THE INVENTION

The Third Generation Partnership Project (3GPP) Packet-switched Streaming Service (PSS) provides a framework for Internet Protocol (IP) based streaming applications in 3G networks. Document 3GPP TS 26.234 V.6.a.0 “Transparent end-to-end Packet-switched Streaming Service (PSS) Protocols and codecs (Release 6)”, incorporated herein by reference, specifies the protocols and codecs for the 3GPP PSS. Protocols for control signaling, capability exchange, media transport, rate adaptation, and stream protection are specified.

In addition, PSS defines an optional Quality of Experience (QoE) metric framework. QoE metric framework is a technique to assess the end user experience of media streaming applications. It enables a combination of cross-layer measurements in extracting results (QoE metrics). The extracted results can be used to monitor and improve the end user experience over variable network conditions.

A 3GPP PSS client supporting the QoE metric feature shall perform the quality measurements in accordance to the measurement definitions, aggregate them into client QoE metrics and report the metrics to the PSS server using the QoE transport protocol when so requested.

QoE metric framework inter alia involves:
QoE metric definitions: A set of QoE metrics are defined for assessing the session level and media level quality of experience. 3GPP TS 26.234 V.6.a.0 provides definitions and recommendations on how to compute these metrics and how often to transmit them.
QoE metric negotiation: A Real-Time Streaming Protocol (RTSP) header “3GPP-QoE-metrics” is defined to enable the PSS client and server to negotiate which QoE metrics the PSS client should send, how often they should be sent and how to turn the metrics transmission off. This header can be sent in requests and responses of RTSP methods SETUP, SET_PARAMETER, OPTIONS (with Session ID) and PLAY. According to 3GPP TS 26.234 V.6.a.0, this negotiation begins with a Session Description Protocol (SDP) file provided by the PSS server or the RTSP SETUP requests from the PSS client, and ends at the latest when the RTSP PLAY response message is issued by the PSS server. A client can simply terminate the negotiation process by issuing an RTSP PLAY request. Once the media transfer begins, no more QoE metric negotiations are allowed, except for turning off the QoE metric feedback.
QoE metric transport: The RTSP header “3GPP-QoE-feedback” is defined and associated with certain RTSP methods (SET_PARAMETER, PAUSE or TEARDOWN) for the transport of the negotiated QoE metrics from the PSS client to the PSS server.

3GPP PSS Release 7 specification (also known as PSSe) is currently under development in 3GPP SA4. The objective of this work item is to enhance the existing Packet Switched Streaming (PSS) specifications with new functionality and state of the art configurations of media codec configurations. One of the main objectives of this work is to improve the PSS channel/content-switching time and also to enable faster start up of PSSe sessions.

As described in Change Request S4-070151 “Fast Content Switching and Start-Up”, related to the 3GPP Release 7 specification, for fast content startup, pipelining of RTSP messages is introduced. In particular, it was agreed to pipeline the RTSP SETUP requests for various media streams and the aggregate control PLAY request to speed up the PSS session start up. This is illustrated in the diagram 100 of FIG. 1, where an exchange of RTSP requests and responses between a client and a server is shown, and where the RTSP SETUP requests for video 101 and audio 102 and the RTSP PLAY request 103 are pipelined.

Similarly, to speed up the PSS channel/content switch, new RTSP headers are defined which enable the establishment of a new PSS session without requiring the tear-down of an old RTSP session and the setup of a new RTSP session. In particular, for fast content switching, an overloaded PLAY request with the “Switch-Stream” header is used to indicate the new content to be streamed to the receiver. This is illustrated in the diagram 200 of FIG. 2, where an exchange of RTSP requests/responses between a server and a client is shown. The client uses an RTSP PLAY request with a “Switch-Stream” header to indicate to the server that a switching of two previous streams to two new streams shall be performed, and the server acknowledges the switching with an RTSP “200 OK” response.

### SUMMARY

The current solutions (for fast channel/content-switching and fast session start up) agreed by the standardization group involve major changes to negotiation protocols prior to the RTSP session establishment. The guiding principle behind these solutions is to get rid of as many round-trip delays as possible by making reasonable assumptions on the similarity between two contents in terms of their media level and session level transport parameters.

In Release 6 of the PSS specification, QoE negotiations may not increase the overall session setup delay. There are multiple round-trips due to separate SETUP requests/response pairs for each media. In this case, the QoE metric negotiations may not contribute significantly to the overall session setup delay, because the QoE metric negotiation headers are piggy-backed to the RTSP SETUP request/response pairs.

In contrast, in Release 7 of the PSS (PSSe), session setup (only) requires one or two round trips. In this case, QoE metric negotiations could significantly contribute to the session setup time, as complete negotiation may not be feasible within a single round trip time.

Using existing QoE negotiation protocols in the PSSe thus leads to increased session setup times and content switching times. It is thus required to modify the QoE metric negotiation process to reflect the new session startup and switching optimizations.

Furthermore, while the Release 7 PSS (PSSe) standardizes solutions to significantly improve the start-up and switching times, the end-user experience during the actual deployment of the service may be different due to varying channel conditions and content compositions (e.g., number of media streams in a content offering and their bitrates). However, QoE metrics for assessing the effectiveness of the PSSe enhancements, and in particular of the user experience during a channel/content switch, do not exist so far.

First Aspect

According to a first aspect of the present invention, a client-side method is disclosed, the method comprising measuring a quality of a transmission session according to one or more metrics to be reported to a server, wherein the one or more metrics comprise a content switch time metric that is related to a time it takes to switch between contents in the transmission session.

According to the first aspect of the present invention, further a computer-readable medium having a computer program stored thereon is disclosed, the computer program comprising instructions operable to cause a processor to perform the client-side method. The computer program is understood to be also disclosed per se, i.e. without being stored on the computer-readable medium.

According to the first aspect of the present invention, even further a client-side device is disclosed, the device comprising a processing unit configured to measure a quality of a transmission session according to one or more metrics to be reported to a server, wherein the one or more metrics comprise a content switch time metric that is related to a time it takes to switch between contents in the transmission session. The device may for instance be a client or a part thereof.

According to the first aspect of the present invention, even further a client-side device is disclosed, the device comprising means for measuring a quality of a transmission session according to one or more metrics to be reported to a server, wherein the one or more metrics comprise a content switch time metric that is related to a time it takes to switch between contents in the transmission session. The device may for instance be a client or a part thereof.

According to the first aspect of the present invention, even further a server-side method is disclosed, the method comprising processing one or more metrics according to which a quality of a transmission session is reported, wherein the one or more metrics comprise a content switch time metric that is related to a time it takes to switch between contents in the transmission session.

According to the first aspect of the present invention, even further a computer-readable medium having a computer program stored thereon is disclosed, the computer program comprising instructions operable to cause a processor to perform the server-side method. The computer program is understood to be also disclosed per se, i.e. without being stored on the computer-readable medium.

According to the first aspect of the present invention, even further a server-side device is disclosed, the device comprising a processing unit configured to process one or more metrics according to which a quality of a transmission session is reported, wherein the one or more metrics comprise a content switch time metric that is related to a time it takes to switch between contents in the transmission session. The device may for instance be a server or a part thereof.

According to the first aspect of the present invention, even further a server-side device is disclosed, the device comprising means for processing one or more metrics according to which a quality of a transmission session is reported, wherein the one or more metrics comprise a content switch time metric that is related to a time it takes to switch between contents in the transmission session. The device may for instance be a server or a part thereof.

According to the first aspect of the present invention, even further a system is disclosed, comprising a client-side device and a server-side device according to the first aspect of the present invention.

According to the first aspect of the present invention, in the transmission session, content is transmitted to a client. Said transmission session may for instance be a streaming session, in which content is streamed to a client via one or more media streams, for instance in a wire-bound or wireless network or a combination thereof. Said media streams may for instance be Real-time Transport Protocol (RTP) media streams. Said content originates from a content source. The transmission session may be set up and controlled by a protocol, for instance the Real-Time Streaming Protocol (RTSP) in case of a streaming session.

In the transmission session, it is possible to switch between contents, for instance in response to a user request. In case of a streaming session, the media transmissions may for instance be media streams. The content may then for instance be switched by replacing content (of the same or different media types) of the media streams, for instance while maintaining the same transport and/or codec parameters of the media streams, and/or by replacing media streams and/or by adding and/or removing media streams. In case the session is controlled by the RTSP, the switching may for instance be accomplished by using a “Switch-Stream” header in an RTSP PLAY request.

At the client, a quality of the transmission session is measured according to one or more metrics and reported to a server for processing, e.g. for evaluation of the quality of the transmission session. Therein, the server to which the metrics are reported may not have to be the content source.

The one or more metrics comprise a content switch time metric, which is related to a time it takes to switch between contents in the transmission session and thus may allow operators or service providers to assess the user experience during a switching of content.

According to an exemplary embodiment of the first aspect of the present invention, the content switch time metric is defined as one of a time from an instant at which a new content on a client is selected to an instant at which a first media frame of the new content is played back, and a time from an instant a switch request is sent from a client to a server to an instant a first media packet of the new content is received at the client. Equally well, the content switch time metric may be defined based on a combination of these two definitions or elements thereof.

According to a further exemplary embodiment of the first aspect of the present invention, the content switch time metric can be negotiated to be reported immediately. For this purpose, a new report rate value “Start” may be defined for the content switch time metric.

According to a further exemplary embodiment of the first aspect of the present invention, the content switch time metric is a quality of experience metric according to the third generation partnership project packet-switched streaming service.

Second Aspect

According to a second aspect of the present invention, a method is disclosed, the method comprising accepting at a client, in case a switching of a previous content to a new content with common media types between the previous and the new content occurs in a transmission session, for reporting a quality of a transmission of the new content, all of the one or more metrics that have already been negotiated between a client and a server for reporting a quality of a transmission of the common media types of the previous content.

According to the second aspect of the present invention, further a computer-readable medium having a computer program stored thereon is disclosed, the computer program comprising instructions operable to cause a processor to perform the method according to the second aspect of the present invention. The computer program is understood to be also disclosed per se, i.e. without being stored on the computer-readable medium.

According to the second aspect of the present invention, even further a device is disclosed, the device comprising a processing unit configured to accept, in case a switching of a previous content to a new content with common media types between the previous and the new content occurs in a transmission session, for reporting a quality of a transmission of the new content, all of the one or more metrics that have already been negotiated between a client and a server for reporting a quality of a transmission of the common media types of the previous content. The device may for instance be a client or a part thereof.

According to the second aspect of the present invention, even further a device is disclosed, the device comprising means for accepting, in case a switching of a previous content to a new content with common media types between the previous and the new content occurs in a transmission session, for reporting a quality of a transmission of the new content, all of the one or more metrics that have already been negotiated between a client and a server for reporting a quality of a transmission of the common media types of the previous content. The device may for instance be a client or a part thereof.

According to the second aspect of the present invention, even further a system is disclosed, the system comprising a server and a client, wherein the client comprises a device according to the second aspect of the present invention.

According to the second aspect of the present invention, even further a protocol is disclosed, the protocol comprising a rule allowing or prescribing that, in case a switching of a previous content to a new content with common media types between the previous and the new content occurs in a transmission session, all of the one or more metrics that have already been negotiated between a client and a server for reporting a quality of a transmission of the previous content are accepted by the client for reporting a quality of a transmission of the common media types of the new content. The protocol may for instance be the QoE negotiation protocol according to the 3GPP PSS.

According to the second aspect of the present invention, in the transmission session, content is transmitted to a client. Said transmission session may for instance be a streaming session, in which content is streamed from a content source to a client via one or more media streams, for instance in a wire-bound or wireless network or a combination thereof. Said media streams may for instance be Real-time Transport Protocol (RTP) media streams. The transmission session may be set up and controlled by a protocol, for instance the Real-Time Streaming Protocol (RTSP) in case of a streaming session.

In the transmission session, it is possible to switch between contents, for instance in response to a user request. In case of a streaming session, said media transmissions may for instance be media streams. The content may then for instance be switched by replacing content (with the same or different media types) of the media streams, for instance while maintaining the same transport and/or codec parameters of the media streams, and/or by replacing media streams and/or by adding and/or removing media streams. In case the session is controlled by the RTSP, the switching may for instance be accomplished by using a “Switch-Stream” header in an RTSP PLAY request.

At the client, a quality of the transmission session is measured according to one or more metrics and reported to a server for processing, e.g. for evaluation of the quality of the transmission session. Therein, the server to which the metrics are reported may not have to be the content source.

Metrics for reporting a quality of a transmission of the previous content have been negotiated between the client and the server. Therein, said negotiation of said metrics may be understood to comprise finding an agreement on the metrics per se and/or on metric values associated with the metrics, for instance a reporting rate indicating how often a metric shall be reported, or a range.

To reduce round-trip times, in case of common media types (such as for instance video, audio, speech, subtitles, etc.), all of the metrics that have already been negotiated for media types of the previous content which media types correspond to some or all media types of the new content are accepted by the client for reporting a quality of the transmission of the new content, so that no more negotiation of these metrics may be required. In other words, if a previous media transmission (e.g. a media stream) and a new media transmission (e.g. a media stream) have the same media type, then the client accepts the same QoE metrics for the new media stream. Said accepting may relate to both the metrics and to the metric values associated with the metrics. The client or the server may turn off the metrics during the session, if required.

According to an exemplary embodiment of the second aspect of the present invention, the client accepts the metrics in a request for playback of the new content.

According to a further exemplary embodiment of the second aspect of the present invention, the metrics are quality of experience metrics according to the third generation partnership project packet-switched streaming service. The metrics may then for instance be accepted in the RTSP PLAY request.

Third Aspect

According to a third aspect of the present invention, a method is disclosed, the method comprising negotiating at least one metric for reporting a quality of a transmission session, wherein client-side negotiating is not started before a launch of a plurality of pipelined requests comprising at least one request for setup of a media transmission in the transmission session and a request for playback of content in the transmission session.

According to the third aspect of the present invention, further a computer-readable medium having a computer program stored thereon is disclosed, the computer program comprising instructions operable to cause a processor to perform the method according to the third aspect of the present invention. The computer program is understood to be also disclosed per se, i.e. without being stored on the computer-readable medium.

According to the third aspect of the present invention, even further a client-side device is disclosed, comprising a processing unit configured to negotiate at least one metric for reporting a quality of a transmission session, wherein client-side negotiating is not started before a launch of a plurality of pipelined requests comprising at least one request for setup of a media transmission in the transmission session and a request for playback of content in the transmission session.

According to the third aspect of the present invention, even further a client-side device is disclosed, comprising means for negotiating at least one metric for reporting a quality of a transmission session, wherein client-side negotiating is not started before a launch of a plurality of pipelined requests comprising at least one request for setup of a media transmission in the transmission session and a request for playback of content in the transmission session.

According to the third aspect of the present invention, even further a system is disclosed, comprising a server and a client, the client comprising a device according to the third aspect of the present invention.

According to the third aspect of the present invention, even further a protocol is disclosed, the protocol comprising a rule prescribing that client-side negotiating of at least one metric for reporting a quality of a transmission session shall not start before a launch of a plurality of pipelined requests comprising at least one request for setup of a media transmission in the transmission session and a request for playback of content in the transmission session. The protocol may for instance be the QoE negotiation protocol according to the 3GPP PSS.

According to the third aspect of the present invention, in the transmission session, content is transmitted to a client. Said transmission session may for instance be a streaming session, in which content is streamed from a content source to a client via one or more media streams, for instance via a wire-bound or wireless network or a combination thereof. Said media streams may for instance be Real-time Transport Protocol (RTP) media streams. The transmission session may be set up and controlled by a protocol, for instance the Real-Time Streaming Protocol (RTSP) in case of a streaming session.

At the client, a quality of the transmission session is measured according to one or more metrics and reported to a server for processing, e.g. for evaluation of the quality of the transmission session. Therein, the server to which the metrics are reported may not have to be the content source.

To ensure a fast session startup, client-side negotiation of the at least one metric does not start before a launch of a plurality of pipelined requests comprising at least one request for setup of a media transmission in the transmission session and a request for playback of content in the transmission session. Therein, the request for playback may be the first request for playback of content in the transmission session, which may for instance be an RTSP session. The plurality of pipelined requests may be understood as a plurality of requests that are launched sequentially, wherein no response to a launched request is awaited before launching the next one. In this way, it is achieved that metric negotiation causes no additional round trip times before playback of content is started. Client-side negotiation may for instance be started with one of the requests in the plurality of pipelined requests, i.e. in a setup request or in a playback request. A client may for instance have been provided with a file (e.g. a Session Description Protocol (SDP) file) describing which metrics a server accepts for reporting a quality of the transmission session. This SDP file may for instance have been sent by a server to the client in response to an RTSP DESCRIBE request of the client. Equally well, the SDP file may be pre-stored at the client or sent to the client via other means. The client may then start client-side negotiation by conveying its choice of the supported metrics (including metric values associated with the metric, such as for instance a reporting rate or a range) in one of the pipelined setup/play requests.

According to an exemplary embodiment of the third aspect of the present invention, the negotiating at least partially takes place after the request for playback of the content. The part of the negotiating that takes place after the client has requested playback of content may not to be limited to turning off quality reporting only. The negotiating or the part of the negotiating that takes place after the client has requested playback of content may at least comprise proposing changed metrics and/or metric values, wherein the change refers to the proposal of the negotiation partner.

According to an exemplary embodiment of the third aspect of the present invention, the metrics are quality of experience metrics according to the third generation partnership project packet-switched streaming service. The client-side negotiating of the at least one metric may then for instance start with a pipelined RTSP SETUP/PLAY request containing a “3GPP-QoE-Metrics” header.

Fourth Aspect

According to a fourth aspect of the present invention, a method is disclosed, the method comprising negotiating at least one metric for reporting a quality of a transmission session, wherein the negotiating at least partially takes place after a client has requested playback of content within the transmission session.

According to the fourth aspect of the present invention, a computer-readable medium having a computer program stored thereon is disclosed, the computer program comprising instructions operable to cause a processor to perform the method according to the fourth aspect of the present invention. The computer program is understood to be also disclosed per se, i.e. without being stored on the computer-readable medium.

According to the fourth aspect of the present invention, even further a client-side device is disclosed, the device comprising a processing unit configured to negotiate at least one metric for reporting a quality of a transmission session, wherein the negotiating at least partially takes place after a client has requested playback of content within the transmission session. The device may for instance be a client or a part thereof.

According to the fourth aspect of the present invention, even further a client-side device is disclosed, the device comprising means for negotiating at least one metric for reporting a quality of a transmission session, wherein the negotiating at least partially takes place after a client has requested playback of content within the transmission session. The device may for instance be a client or a part thereof.

According to the fourth aspect of the present invention, even further a server-side device is disclosed, the device comprising a processing unit configured to negotiate at least one metric used by a client to report a quality of a transmission session, wherein the negotiating at least partially takes place after the client has requested playback of content within the transmission session. The device may for instance be a client or a part thereof.

According to the fourth aspect of the present invention, even further a server-side device is disclosed, the device comprising means for negotiating at least one metric used by a client to report a quality of a transmission session, wherein the negotiating at least partially takes place after the client has requested playback of content within the transmission session. The device may for instance be a client or a part thereof.

According to the fourth aspect of the present invention, even further a system is disclosed, the system comprising a client comprising a client-side device according to the fourth aspect of the present invention and a server comprising a server-side device according to the fourth aspect of the present invention.

According to the fourth aspect of the present invention, even further a protocol is disclosed, the protocol comprising a rule allowing that at least one metric for reporting a quality of a transmission session is at least partially negotiated after a client has requested playback of content within the transmission session.

According to the fourth aspect of the present invention, in the transmission session, content is transmitted to a client. Said transmission session may for instance be a streaming session, in which content is streamed from a content source to a client via one or more media streams, for instance in a wire-bound or wireless network or a combination thereof. Said media streams may for instance be Real-time Transport Protocol (RTP) media streams. The transmission session may be set up and controlled by a protocol, for instance the Real-Time Streaming Protocol (RTSP) in case of a streaming session.

At the client, a quality of the transmission session is measured according to one or more metrics and reported to a server for processing, e.g. for evaluation of the quality of the transmission session. Therein, the server to which the metrics are reported may not have to be the content source.

The playback request may for instance be the first playback request in the transmission session. In this case, said negotiating may also completely take place after the client has requested playback of content. Equally well, the playback request may be a later playback request in the transmission session.

Said content for which said playback is requested may for instance at least partially differ from the content for which the at least one metric is negotiated. For instance, a playback may have been requested for a first content of said transmission session, and, during or after a switch of content from the first content to a second content, negotiation of the at least one metric for the second content is started. Said negotiating may also completely take place after the client has requested playback of content.

The at least one metric is negotiated between the client and the server. The part of the negotiating that takes place after the client has requested playback of content may not to be limited to turning off quality reporting only. The negotiating or the part of the negotiating that takes place after the client has requested playback of content may at least comprise proposing changed metrics and/or metric values, wherein the change refers to the proposal of the negotiation partner.

According to an exemplary embodiment of the fourth aspect of the present invention, in case a switching of a previous content to a new content comprising at least one additional or different media stream as compared to the media streams in the previous content occurs, the client starts negotiating the at least one metric for the at least one media stream by inserting information related to the at least one metric into one of a request for setup of the at least one media stream in the transmission session and a request for playback of the new content in the transmission session, both of which requests are pipelined and sent from the client to the server.

The media streams may for instance be RTP media streams. The content may for instance be switched by replacing content (of the same or different media type) of said media streams, for instance while maintaining the same transport and/or codec parameters of the media streams, and/or by replacing media streams and/or by adding and/or removing media streams.

Therein, the information related to the at least one metric may for instance be information indicating if the client wishes to use the metric and/or a proposal for a metric value associated with the metric.

Therein, the sending in pipelined form may be understood as a sequential sending of the requests, wherein a second request of the requests is sent without waiting for a response to a first request of the requests. In a 3GPP PSS system, the information related to the at least one metric may for instance be inserted into the pipelined RTSP SETUP request of the new media or the pipelined aggregate RTSP PLAY request of the content.

According to a further exemplary embodiment of the fourth aspect of the present invention, the metrics are quality of experience metrics according to the third generation partnership project packet-switched streaming service.

Fifth Aspect

According to a fifth aspect of the present invention, a method is disclosed, comprising inheriting, in case a switching of a previous content to a new content occurs within a transmission session, at least one metric negotiated between a client and a server for reporting a quality of a transmission of the previous content.

According to the fifth aspect of the present invention, further a computer-readable medium having a computer program stored thereon is disclosed, the computer program comprising instructions operable to cause a processor to perform the method according to the fifth aspect of the present invention. The computer program is understood to be also disclosed per se, i.e. without being stored on the computer-readable medium.

According to the fifth aspect of the present invention, even further a device is disclosed, the device comprising a processing unit configured to inherit, in case a switching of a previous content to a new content occurs within a transmission session, at least one metric negotiated between a client and a server for reporting a quality of a transmission of the previous content.

According to the fifth aspect of the present invention, even further a device is disclosed, the device comprising means for inheriting, in case a switching of a previous content to a new content occurs within a transmission session, at least one metric negotiated between a client and a server for reporting a quality of a transmission of the previous content.

According to the fifth aspect of the present invention, even further a system is disclosed, the system comprising a server and a client, and the client comprising a device according to the fifth aspect of the present invention.

According to the fifth aspect of the present invention, even further a protocol is disclosed, the protocol comprising a rule allowing or prescribing that, in case a switching of a previous content to a new content occurs within a transmission session, at least one metric negotiated between a client and a server for reporting a quality of a transmission of the previous content is inherited.

According to the fifth aspect of the present invention, in the transmission session, content is transmitted to a client. Said transmission session may for instance be a streaming session, in which content is streamed from a content source to a client via one or more media streams, for instance in a wire-bound or wireless network or a combination thereof. Said media streams may for instance be Real-time Transport Protocol (RTP) media streams. The transmission session may be set up and controlled by a protocol, for instance the Real-Time Streaming Protocol (RTSP) in case of a streaming session.

At the client, a quality of the transmission session is measured according to one or more metrics and reported to a server for processing, e.g. for evaluation of the quality of the transmission session. Therein, the server to which the metrics are reported may not have to be the content source.

In the transmission session, it is possible to switch between contents, for instance in response to a user request. In case of a streaming session, the content may then for instance be switched by replacing content (of the same or different media type) of media streams, for instance while maintaining the same transport and/or codec parameters of the media streams, and/or by replacing media streams and/or by adding and/or removing media streams. In case the session is controlled by the RTSP, the switching may for instance be accomplished by using a “Switch-Stream” header in an RTSP PLAY request.

If such a switching of content occurs, at least one metric negotiated between a client and a server for reporting a quality of a streaming of the previous content is inherited. Equally well, all metrics negotiated between a client and a server for reporting a quality of a transmission of the previous content may be inherited by the new content. Inheriting may mean that the metrics that have already been negotiated for the previous content do not need to be re-negotiated in order to be applicable to the new content after the switching occurs, but they apply to the latter content immediately after the switching. It could for instance be prescribed for the client (for instance in the SDP file or in an any of the RTSP requests prior to/during a content switch) that the metrics are inherited and for the server that it shall be assumed that the metrics are inherited.

Unless explicitly modified or stopped, the reporting of the quality of the new content may continue at the same rate as for the previous content. Thus no negotiation of metrics for the new content may be required. However, when reporting events that happen after the switching of contents is accomplished, the uniform resource locators related to the new content may be used instead of the uniform resource locators related to the previous content.

In addition to inheriting of already negotiated metrics, further metrics may be negotiated (e.g. for media streams of the new content that are different from the media streams of the previous content). This negotiating may be allowed to at least partially take place after a play request has been issued by the client.

According to an exemplary embodiment of the fifth aspect of the present invention, a reporting rate for the previous content is the same as a reporting rate for the new content. Unless explicitly modified or stopped, the quality reporting may continue at the same rate as for the previous media stream or content.

According to an exemplary embodiment of the fifth aspect of the present invention, it is prescribed for the client in one of an SDP file and a request prior to or during said switching of content that said at least one metric shall be inherited. Said request may for instance be an RTSP request.

According to a further exemplary embodiment of the fifth aspect of the present invention, the metrics are quality of experience metrics according to the third generation partnership project packet-switched streaming service.

These and other aspects of the invention will be apparent from and elucidated with reference to the detailed description presented hereinafter.

The features of the different aspects of the present invention and of their exemplary embodiments as presented above shall be understood to be disclosed also in all possible combinations with each other.

### BRIEF DESCRIPTION OF THE FIGURES

In the figures show:

FIG. 1: An exemplary illustration of a fast session startup according to a packet-switched streaming service;

FIG. 2: an exemplary illustration of a fast content switch according to a packet-switched streaming service;

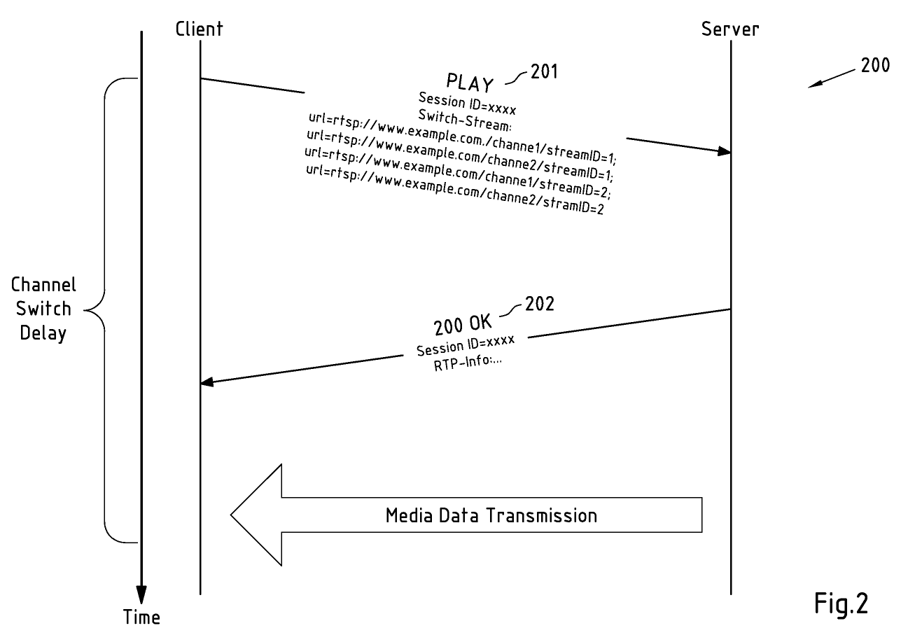

FIG. 3: a schematic block diagram of an exemplary embodiment of a system according to the present invention;

FIG. 4: a flowchart of an exemplary embodiment of a method according to the first aspect of the present invention;

FIG. 5: a schematic illustration of the calculation of the Content_Switch_Time metric according to the first aspect of the present invention;

FIG. 6: a flowchart of an exemplary embodiment of a method according to the second aspect of the present invention;

FIG. 7: a flowchart of an exemplary embodiment of a method according to the third aspect of the present invention; and

FIG. 8: a flowchart of an exemplary embodiment of a method according to the fourth aspect of the present invention.

FIG. 9: a flowchart of an exemplary embodiment of a method according to the fifth aspect of the present invention.

### DETAILED DESCRIPTION OF THE INVENTION

In the following detailed description of the present invention, exemplary embodiments of the present invention will be described in the context of a Third Generation Partnership Project (3GPP) Packet-switched Streaming Service (PSS) system.

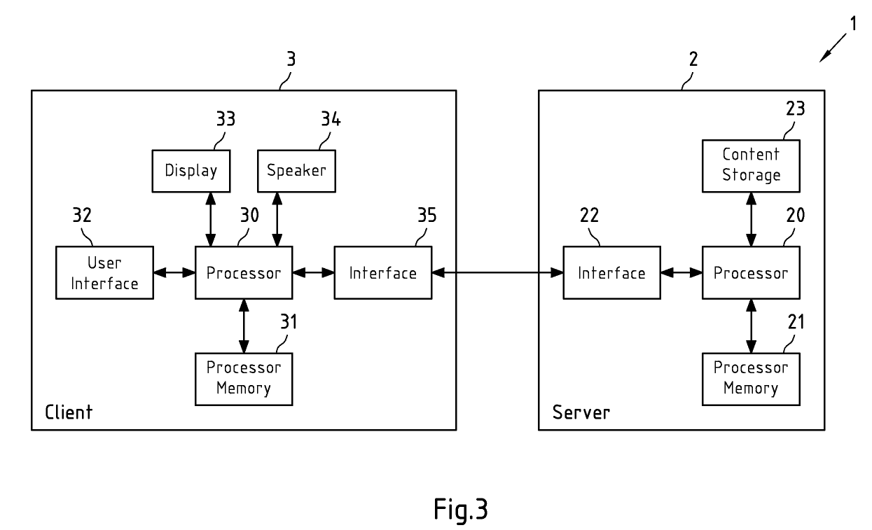

FIG. 3 is a schematic block diagram of an exemplary embodiment of a system 1 according to the present invention. System 1 comprises a PSS server 2 and a PSS client 3.

Server 2 comprises a processor 20 that controls overall operation of server 2. Processor 20 executes program code stored in processor memory 21, which may for instance be embodied as fixedly built-in memory such as a Random Access Memory (RAM) or Read-Only-Memory (ROM) or as a removable memory such as a memory card or an optical storage medium. Processor 20 has access to a content storage, which stores content to be streamed to client 3. Therein, the content may for instance be understood to be composed of one or more media streams, such as for instance audio and video streams or speech. Via interface 22, which may for instance be a packet-switched interface, processor 20 is able to communicate with client 3.

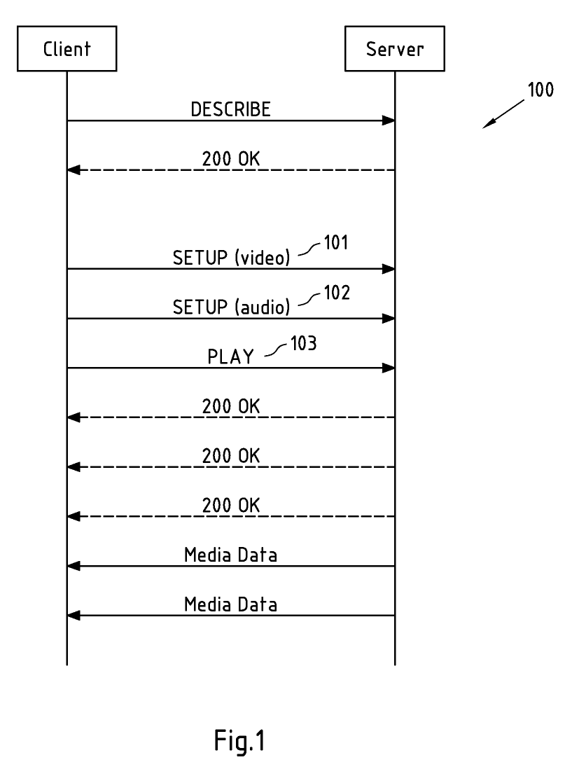

It should be noted that content may alternatively be stored in one or more dedicated content servers, and in this case server 2 of FIG. 1 then would function only as RTSP server for setting up and controlling a streaming session between client 3 and such a content server. For the sake of simplicity, it is however exemplarily assumed in FIG. 1 that RTSP server and content server are co-located.

Processor 20 implements all functionality to stream content from server 2 to client 3 in a streaming session, and to monitor the quality of the streaming session. To this end, processor 20 implements a protocol stack for the streaming of content, which comprises an adaptation layer for converting the payload of the content to the format of the Real-Time Transport Protocol (RTP), the RTP, a User Datagram Protocol (UDP) and an Internet Protocol (IP). Furthermore, processor 20 implements a protocol stack for the set-up and control of this streaming, comprising a Real-Time Streaming Protocol (RTSP), which is either based on a Transport Control Protocol (TCP) or on a UDP, both being based on the IP. The RTSP at least may require a presentation description, for instance according to the Session Description Protocol (SDP), to setup a streaming session. The RTSP further serves to negotiate Quality of Experience (QoE) metrics between server 2 and client 3 and to transfer these QoE metrics from client 3 to server 2.

Client 3 comprises a processor 30 for controlling its overall operation. Processor 30 executes program code stored in processor memory 31, which may for instance be embodied as fixedly built-in memory such as a Random Access Memory (RAM) or Read-Only-Memory (ROM) or as a removable memory such as a memory card or an optical storage medium. Processor 30 controls a user interface 32 for receiving user input, and a display 33 and a speaker 34 for rendering content that is streamed from server 2 to client 3 within a streaming session. Client 3 further comprises an interface 35 to communicate with server 2. Said interface may for instance be a packet-based interface.

To provide functionality to participate in a streaming session, and to be able to report QoE metrics related to this streaming session to server 2, processor 30 of client 3 implements protocol stacks that correspond to the protocol stack implemented by processor 20 of server 20, i.e. a protocol stack comprising an adaptation layer, a RTP, a UDP, an IP, an RTSP and optionally a TCP.

In order to offer service providers in PSS systems means to evaluate the end user streaming experience, streaming service QoE metrics have been introduced in PSS systems. Client 3 measures and feedbacks information on the quality of the actual streaming application to server 3, wherein the quality is defined in terms of the QoE metrics. The quality metrics may for instance be transported by using the RTSP and SDP. Equally well, other protocols could be used to carry the QoE metrics, for instance the Session Initiation Protocol (SIP), the Extended Markup Language (XML), the Hypertext Transfer Protocol (HTTP) or the Short Message Service (SMS), to name but a few possibilities.

The client 3 in a PSS system with quality feedback is responsible to perform the quality measurements in accordance to the measurement definition, aggregate them into streaming client quality metrics and report the metrics to server 2.

Server 2 is responsible to signal the activation of the client's QoE metrics reporting and to gather the client's QoE metrics. Server 2 may process the received client's QoE metrics to build aggregated quality metrics. E.g. it could receive a raw lost packets report and build the Min, Max, Avg and Std packet loss rate for a particular client.

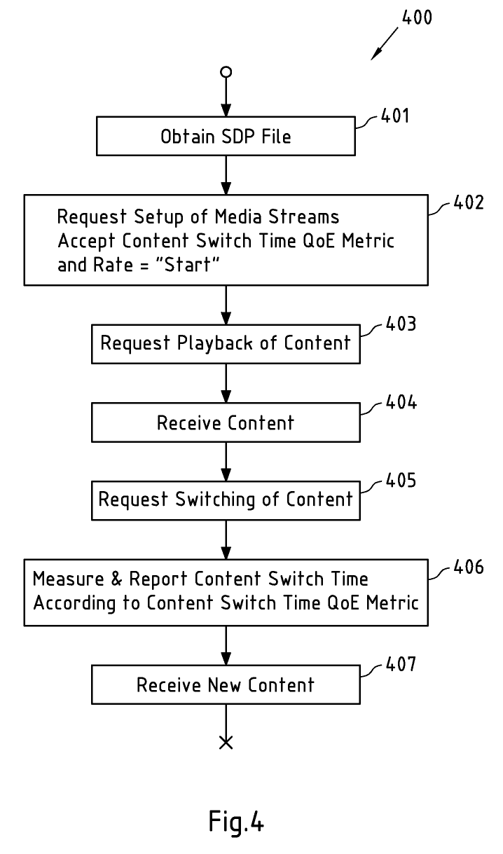

The specific operation of system 1 with respect to the different aspects of the present invention will be described in more detail with reference to the flowcharts of FIG. 4, 6, 7, 8 and 9 below.

According to the first aspect of the present invention, a new QoE metric “Content_Switch_Time” is proposed to allow a client to report a content switch time to the server. This Content_Switch_Time QoE metric is particularly useful since it allows the operators or service providers to assess the user experience during a channel/content switch and thus to assess the effectiveness of the PSSe enhancements.

The format of this Content_Switch-Time QoE metric report is specified as follows in Augmented Backus-Naur Format (ABNF):
Parameters=“Content_Switch Time” “=”
“{” switch-time-msec [SP Timestamp] “}”
Switch-time-msec=1*DIGIT

This definition fits well to the QoE feedback report syntax of the 3GPP PSS.

The Timestamp parameter for this metric is used to indicate the time (e.g., expressed in Normal Play Time (NPT)) at which the switch operation has been initiated. This time is according to the timeline of the previous content.

The Content_Switch_Time QoE metric may for instance be defined as the time (e.g., expressed in milliseconds) from the instant the user selects a new content on the client to the instant the first media frame is played back. Alternatively, it may be defined as the time (e.g., in milliseconds) from the instant the switch request is sent from the client to the server to the instant the first media packet of the new media stream is received at the client. It can also be any combination of those above definitions.

It may be advantageous that it is possible to ask for immediate reporting of the Content_Switch_Time QoE metric value. For this purpose, a new report rate value “Start” may be defined for the Content_Switch_Time QoE metric.

The first aspect of the present invention is advantageously implemented in a backwards compatible way to the QoE framework in 3GPP PSS. For instance, the signalling of the new QoE metric may be done in the SDP file or in any of the RTSP request/response messages. The Content_Switch_Time QoE metric may be reported immediately after the content switch is finalized, if the negotiated rate is set to “Start”. Alternatively, it may be reported at the end of the current content session, if the rate is set to “End”.

The content switch time may always be calculated based on the NPT of the previous content. If the content switch time is reported immediately after the start, then the NPT timestamp of the previous content may be included. Otherwise, the timestamp may not be useful to report.

The content switch time is calculated in milliseconds and is not subject to NPT time scaling.

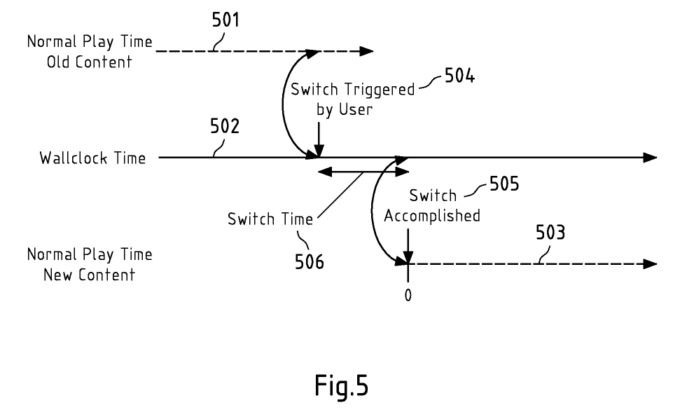

FIG. 5 depicts the content switch time calculation. It shows the NPT of the old content 501, the wallclock time 502 and the NPT of the new content 503. The content switch time 506 is then obtained as the difference between the instant 505 the switching between contents is accomplished (e.g. the instant the first media frame is played back or the instant the first media packet of the new media stream is received at the client) and the instant 504 the switching is triggered by a user (e.g. the instant the user selects a new content or the instant the switch request is sent from the client to the server), wherein this difference is measured according to the wallclock time scale 502.

A range value, if specified for the Content_Switch_Time QoE metric, may indicate the period in which content switch times are to be reported if content switches happen during that interval. The range applies to the previous content.

FIG. 4 depicts a flowchart 400 of an exemplary embodiment of a method according to the first aspect of the present invention. The steps of flowchart 400 may for instance be performed by processor 30 of client 3 (see FIG. 3) to report the Content_Switch_Time QoE metric to server 2. Therein, the sequence of steps in this flowchart, and also in all other flowcharts presented in this specification, shall not be understood to be binding, also deviating sequences of these steps may be used.

In a first step 401, an SDP file is obtained, for instance in response to an RTSP DESCRIBE request. Equally well, the SDP file may be received via the HTTP, or may be otherwise available to client 3, for instance be stored at a location where it can be accessed by client 3. The SDP file may for instance be pre-stored in the client. The SDP file contains the QoE metrics and the associated QoE metrics values (such as for instance the reporting rate) that are supported by server 2. For simplicity of presentation, it is assumed that the server only supports the Content_Switch_Time QoE metric with rate=“Start”.

In a step 402, client 3 requests setup of media streams with a specific content (via RTSP SETUP requests). In these RTSP SETUP requests, the “3GPP-QoE-Metrics” header is included and configured to notify to server 2 that all QoE metrics of the SDP file and the associated QoE metric values (i.e. the Content_Switch _Time QoE metric with rate=“Start”) are accepted by client 3. In fact, QoE metric negotiation then may be considered to be terminated. Nevertheless, server 2 may echo the accepted parameters in a response to the RTSP setup request, to re-acknowledge client 3.

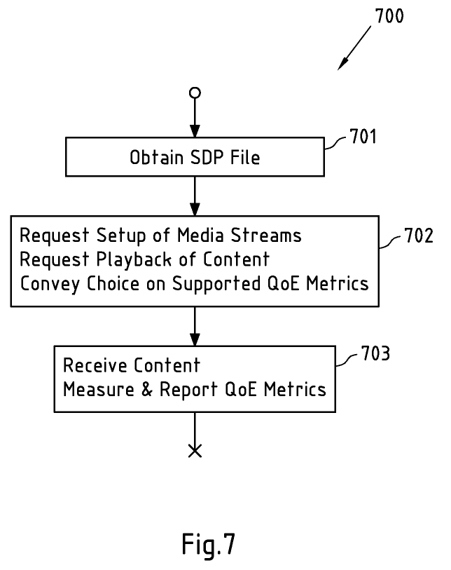

In a step 403, client 3 requests playback of the content, via an RTSP PLAY request. To reduce the session setup time, this request may also be sent together with the RTSP SETUP request in pipelined form, i.e. without waiting for a response to the RTSP SETUP request before sending the RTSP PLAY request. In this case, in effect the third aspect of the present invention would be implemented, as will be discussed below with reference to FIG. 7.

Returning to FIG. 4, in a step 404, client 3 then receives content from server 2.

In a step 405, client 3 has decided to switch content, and may for instance issue an overloaded RTSP PLAY request with an included RTSP “Switch-Stream” header to server 2. This causes a switching of content to take place.

In a step 406, since the reporting rate associated with the Content_Switch_Time QoE metric was negotiated to the value “Start” (implying instantaneous reporting of the content switch time after a switching of content has occurred), client 3 measures the content switch time associated with the switching of the content, aggregates the measurement result into the Content_Switch_Time QoE metric and sends this QoE metric to server 2, for instance via the “3GPP-QoE-feedback” header included into an RTSP SET_PARAMETER request.

Finally, in step 407, client 3 receives the new content.

In the following, an alternative, yet more detailed example of the negotiation of the Content_Switch_Time QoE metric according to the first aspect of the present invention will be provided. Therein, the notation “S→C” indicates that information is sent from the server (S) to the client (C), whereas the notation “C→S” indicates that information is sent from client to server. Information pertaining to the Content_Switch_Time QoE metric is given in bold face. Furthermore, the relevant metric values that are negotiated are underlined.

Initially, in response to an RTSP DESCRIBE request of client 3, server 2 provides the following SDP file in a response message (this response message may for instance be received in step 401 of flowchart 400 of FIG. 4):

| | |
|---|---|
| S->C | RTSP/1.0 200 OK |
| | Cseq: 1 |
| | Content-Type: application/sdp |
| | Content-Base: rtsp://example.com/foo/bar/baz.3gp/ |
| | Content-Length: 800 |
| | Server: PSSR6 Server |
| | v=0 |
| | o=- 3268077682 433392265 IN IP4 63.108.142.6 |
| | s=QoE Enables Session Description Example |
| | e=support@foo.com |
| | c=IN IP4 0.0.0.0 |
| | t=0 0 |
| | a=range:npt=0–83.660000 |
| | a=3GPP-QoE-Metrics:{Content_Switch_Time};rate=Start |
| | a=control:* |
| | m=video 0 RTP/AVP 96 |
| | b=AS:28 |
| | a=3GPP-QoE-Metrics:{Content_Switch_Time};rate=Start |
| | a=control:trackID=3 |
| | a=rtpmap:96 MP4V-ES/1000 |
| | a=range:npt=0–83.666000 |
| | a=fmtp:96profile-level-id=8;config=000001b008000001b |
| | 50900012000 |
| | m=audio 0 RTP/AVP 98 |
| | b=AS:13 |
| | a=3GPP-QoE-Metrics:{Content_Switch_Time};rate=Start |
| | a=control:trackID=5 |
| | a=rtpmap:98 AMR/8000 |
| | a=range:npt=0−83.660000 |
| | a=fmtp:98 octet-align=1 |
| | a=maxptime:200 |

The following requests show the negotiation of the Content_Switch_Time QoE metric in RTSP SETUP and PLAY requests launched by client 3 and in the responses thereto launched by server 2. The examples shows the negotiation of the reporting rate which was changed by client 3 from “Start” to “End”, and then from server 2 from “End” to “Start” (this negotiation thus deviates from the negotiation in step 402 of the flowchart 400 of FIG. 4, where the QoE metric and associated rate in the SDP file were directly accepted by client 3). The client 3 finally accepts the rate “Start” in the RTSP PLAY request.

| | |
|---|---|
| C->S | SETUP rtsp://example.com/foo/bar/baz.3gp/trackID=1 |
| | RTSP/1.0 |
| | Cseq: 2 |
| | 3GPP-QoE-Metrics:url=”rtsp://example.com/foo/bar/baz.3 |
| | gp/trackID=3”; |
| | metrics={Content_Switch_Time};rate=End |
| C->S | SETUP rtsp://example.com/foo/bar/baz.3gp/trackID=2 |
| | RTSP/1.0 |
| | Cseq: 3 |
| | 3GPP-QoE-Metrics:url=”rtsp://example.com/foo/bar/baz.3 |
| | gp/trackID=5”; |
| | metrics={Content_Switch_Time};rate=End |
| S->C | RTSP/1.0 200 OK |
| | Cseq: 2 |
| | Session: 17903320 |
| | Transport: |
| | RTP/AVP;unicast;client_port=7000–7001;server_port= |
| | 6970–6971 |
| | 3GPP-QoE-Metrics:url=”rtsp://example.com/foo/bar/baz.3 |
| | gp/trackID=3”; |
| | metrics={Content_Switch_Time};rate=Start |
| S->C | RTSP/1.0 200 OK |
| | Cseq: 3 |
| | Session: 17903320 |
| | Transport: |
| | RTP/AVP;unicast;client_port=7004–7005;server_port= |
| | 6900–6901 |
| | 3GPP-QoE-Metrics:url=”rtsp://example.com/foo/bar/baz.3 |
| | gp/trackID=5”; |
| | metrics={Corruption_Duration\|Decoded_Bytes};rate=Start |
| C->S | PLAY rtsp://example.com/foo/bar/baz.3gp RTSP/1.0 |
| | Cseq: 4 |
| | 3GPP-QoE-Metrics:url=”rtsp://example.com/foo/bar/baz.3 |
| | gp/trackID=3”; |
| | metrics={Content_Switch_Time};rate=Start, |
| | 3GPP-QoE-Metrics:url=”rtsp://example.com/foo/bar/baz.3 |
| | gp/trackID=5”; |
| | metrics={Content_Switch_Time};rate=Start |

The following request is an example of the feedback of the Content_Switch_Time QoE metric. Here, the content switch time is 200 ms, and this content switch was initiated at NPT timestamp 2105.2 of the previous content (this feedback may for instance be performed in step 406 of the flowchart 400 of FIG. 4).

| | |
|---|---|
| C->S | SET_PARAMETER rtsp://example.com/foo/bar.3gp RTSP/1.0 |
| | Cseq: 201 |
| | Session: 2359872 |
| | 3GPP-QoE-Feedback: |
| | url=“rtsp://example.com/foo/bar.3gp/trackID=1”; |
| | Content_Switch_Time={200 2105.1} |
| | Content-length: 0 |

The second aspect of the present invention is related to adapting the QoE metric negotiation protocol to switching of content and proposes that, if content of the previous media stream and content of the new media stream have the same media type, the client shall accept the same QoE metrics in the “Switch-Stream” header of the PLAY request for the new content. No more negotiation of these parameters is needed. The client or the server may turn off the metrics during the session, if needed.

Furthermore, also the fourth aspect of the present invention is related to adapting the QoE metric negotation protocol to switching of content and proposes to allow QoE metric negotiation after the PLAY request (e.g. the initial PLAY request of the session). For example, for new content with more media streams than in the old content, the QoE metric for the new media stream may be negotiated during the session (currently not allowed in Release 6). The client shall include its choice of the supported QoE metrics in the pipelined SETUP request of the new media or the pipelined aggregate PLAY request of the content (For new content with fewer media streams than in the old content, no more QoE metric negotiation may be needed.).

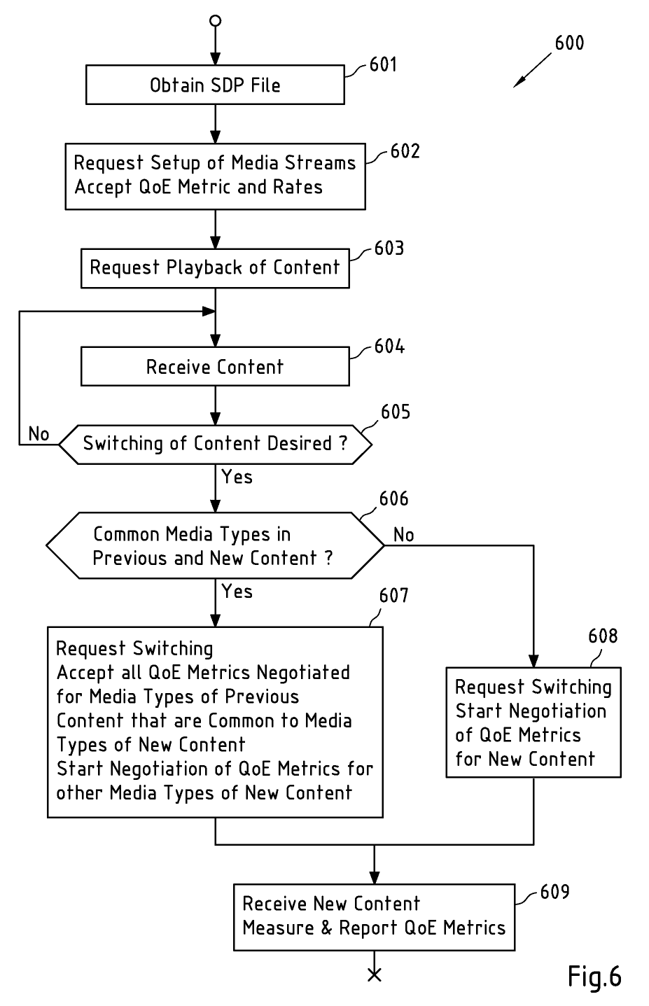

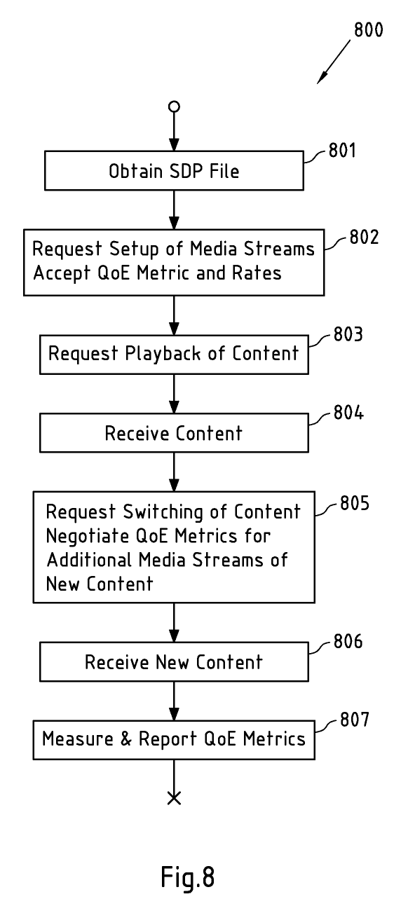

FIG. 6 depicts a flowchart 600 of an exemplary embodiment of a method according to the second and fourth aspect of the present invention. The steps of this flowchart may for instance be performed by processor 30 of client 3 of the system 1 of FIG. 3. In this flowchart, it is exemplarily assumed that the number of media streams in the switching of content remains the same. The case of additional media streams after the switching is covered by the flowchart 800 of FIG. 8.

In a first step 601, an SDP file is obtained by client 3, for instance in response to an RTSP DESCRIBE request. The SDP file may also be pre-stored in the client.

In a step 602, client 3 requests setup of media streams (via the RTSP SETUP request), and accepts all QoE metrics and the associated metrics values as proposed by server 2 in the SDP file.

In step 603, client 3 then requests playback of content via the RTSP PLAY request, and in step 604, content is received.

In a step 605, it is determined if a switching of content is desired. If this is not the case, the flowchart returns to step 604. Otherwise, it is checked if there are common media types in the previous and the new content (e.g. video/audio/speech etc. media types).

If this should be the case, the second aspect of the present invention can be applied in a step 607, i.e. all QoE metrics (and the associated metric values, i.e. the reporting rate) negotiated for media types (e.g. video, audio, speech, subtitles, etc.) of the previous content that are common to media types of the new content are accepted, for instance in an RTSP PLAY request.

If the new content additionally comprises media types that are different from the media types of the previous content, the fourth aspect of the present invention can also be applied in step 607, i.e. negotiation of QoE metrics for these media types is allowed, although this negotiation will at least partially take place after an RTSP PLAY request has been launched. For instance, client 3 may start negotiation by conveying its choice on the QoE metrics (including the associated QoE metric values) in a pipelined RTSP SETUP request for the new media or in the pipelined aggregate RTSP PLAY request for the new content. If server 2 does not agree with the client's choice of QoE metrics, it is still allowed to proceed with negotiation, for instance by proposing deviating parameters in a response to the RTSP SETUP or PLAY requests. Therein, the SDP file containing a description of the QoE metrics for the new content may have been sent to client 3 in response to a DESCRIBE request, or may be pre-stored in the client, or may be requested during the switch (not shown in FIG. 6) and sent to the client via RTSP or other means.

Similarly, if it is determined in step 606 that there are no common media types in the previous and new content, the fourth aspect of the present invention can be applied in step 608, i.e. negotiation of QoE metrics for the new media types is started, although this negotiation will at least partially take place after an RTSP PLAY request has been launched. Client 3 may start negotiation by conveying its choice on the QoE metrics (including the associated QoE metric values) in a pipelined RTSP SETUP request for the new media or in the pipelined aggregate RTSP PLAY request for the content. As already stated above, also in this case the SDP file containing a description of the QoE metrics for the new content may have been sent to client 3 in response to a DESCRIBE request, or may be pre-stored in the client, or may be requested during the switch (not shown in FIG. 6) and sent to the client via RTSP or other means.

In a step 609, then the new content is received, and the negotiated QoE metrics are measured and reported.

The third aspect of the present invention is directed to adapting the QoE metric negotiation protocol to fast session setup and proposes that, for fast session startup, no QoE metric negotiations shall be added before the PLAY request. In one of the pipelined SETUP/PLAY requests, the client shall convey its choice of the supported QoE metrics which it received in the SDP file.

FIG. 7 depicts a flowchart 700 of an exemplary embodiment of a method according to the third aspect of the present invention. The steps of this flowchart may for instance be performed by processor 30 of client 3 of the system 1 of FIG. 3.

In a first step 701, an SDP file is obtained by client 3, for instance in response to an RTSP DESCRIBE request. The SDP file may for instance also be pre-stored in the client or sent to the client via other means.

In a step 702, client 3 launches a couple of pipelined requests, i.e. sequentially launches a couple of requests, wherein a second request is sent without awaiting a response to the already sent first request, a third request is sent without awaiting a response to the sent second request, and so on.

These pipelined requests comprise RTSP SETUP requests for setting up media streams of content to be streamed in a streaming session and an aggregate RTSP PLAY request for triggering playback of all media streams aggregated in the content. The client's choice on the supported QoE metrics is included via a “3GPP-QoE-metrics” header either in the RTSP SETUP requests or in the RTSP PLAY request.

The server may either accept the client's choice in a response message, which terminates the negotiation, or may make a proposal that deviates from the client's choice. In the latter case (which is not depicted in the flowchart of FIG. 7), application of the proposal according to the fourth aspect of the present invention, according to which negotiation is allowed to at least partially take place after playback has been requested, is advantageous, since otherwise, negotiation may not be completed.

Since, according to the third aspect of the present invention, negotiation is not started before an RTSP play request, additional round trip times caused by QoE metric negotiations are avoided, and fast session setup is ensured.

In a last step 703 of the flowchart 700, content is then received, and the QoE metrics are measured and reported as negotiated.

As already stated above, also the fourth aspect of the present invention is related to adapting the QoE metric negotation protocol to switching of content and proposes to allow QoE metric negotiation after the PLAY request (e.g. the initial PLAY request of the session). For example, for new content with more media streams than in the old content, the QoE metric for the new media stream may be negotiated during the session (currently not allowed in Release 6). The client shall include its choice of the supported QoE metrics in the pipelined SETUP request of the new media or the pipelined aggregate PLAY request of the content (For new content with fewer media streams than in the old content, no more QoE metric negotiation is needed.).

FIG. 8 depicts a flowchart 800 of an exemplary embodiment of a method according to the fourth aspect of the present invention. The steps of this flowchart may for instance be performed by processor 30 of client 3 of the system 1 of FIG. 3.

In a first step 801, an SDP file is obtained by client 3, for instance in response to an RTSP DESCRIBE request. The SDP file may also be pre-stored in the client or sent to the client via other means.

In a step 802, client 3 requests setup of media streams (via the RTSP SETUP request), and accepts all QoE metrics and the associated metrics values as proposed by server 2 in the SDP file.

In step 803, client 3 then requests playback of content via the RTSP PLAY request, and in step 804, content is received. The RTSP PLAY request of step 802 is thus the first RTSP PLAY request in the streaming session.

In step 805, client 3 requests switching of content. Therein, it is exemplarily assumed that the new content comprises more media streams than the old content, i.e. one or more media streams are added when switching content. Whereas the already negotiated QoE metrics for the maintained media streams may be accepted according to the second aspect of the present invention, if the media types of these media streams remain unchanged, the QoE metrics for the additional media stream(s) may require negotiation. It may thus be advantageous to allow that negotiation may also take place after the initial RTSP PLAY request 803.

For instance, client 3 may include its choice of the supported QoE metrics in the pipelined RTSP SETUP request of the new media stream or the pipelined aggregate RTSP PLAY request of the new content, in order to start negotiation. Server 2 then may, in a response to the request, accept the proposed QoE metrics and the QoE metric values or make a differing proposal. Client 3 then in turn may either accept or make further differing proposals.

The SDP file containing a description of the QoE metrics for the new content may have been sent to client 3 in response to a DESCRIBE request, or may be pre-stored in the client, or may be requested during the switch (not shown in FIG. 8) and sent to the client via RTSP or other means.

In step 806, the new content is then received, and in a step 807, the QoE metrics are measured and reported.

The fifth aspect of the present invention is related to adapting the QoE metric negotiation protocol to switching of content and proposes that already negotiated QoE metrics are inherited by the new content. Unless explicitly modified or stopped, the reporting continues at the same rate as for the prior media stream or content. However, when reporting events that happen after the switch is accomplished, the new URLs shall be used instead of the old ones.

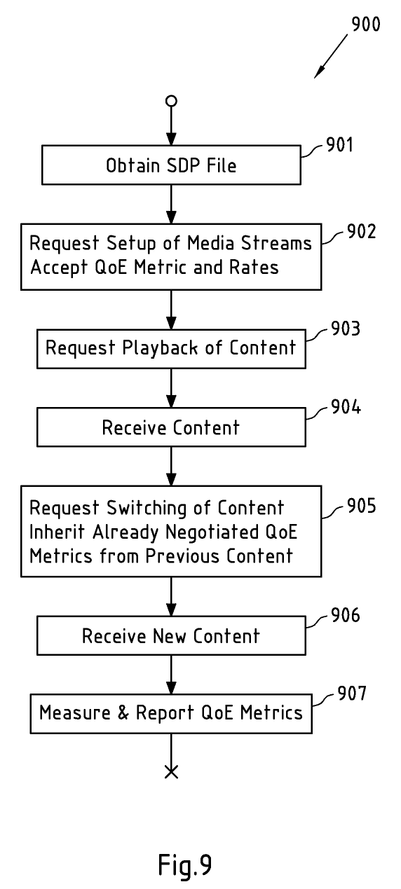

FIG. 9 depicts a flowchart 900 of an exemplary embodiment of a method according to the fifth aspect of the present invention. The steps of this flowchart may for instance be performed by processor 30 of client 3 of the system 1 of FIG. 3.

In a first step 901, an SDP file is obtained by client 3, for instance in response to an RTSP DESCRIBE request. The SDP file may also be pre-stored in the client or sent to the client via other means.

In a step 902, client 3 requests setup of media streams (via the RTSP SETUP request), and accepts all QoE metrics and the associated metrics values as proposed by server 2 in the SDP file.

In step 903, client 3 then requests playback of content via the RTSP PLAY request, and in step 904, content is received.

In step 905, client 3 requests switching of content, and inherits already negotiated QoE metrics from the previous content. Inheriting means that the QoE metrics that have already been negotiated for the previous content do not need to be re-negotiated in order to be applicable to the new content after the switching occurs, but they apply to the latter content immediately after the switching.

In addition to inheriting of already negotiated metrics, further metrics may be negotiated (e.g. for media streams of the new content that are different from the media streams of the previous content). This negotiating may be allowed to take place after a play request has been issued by the client (i.e. according to the fourth aspect of the present invention), and may for instance start with a proposal of QoE metrics (and associated QoE metric values) in a pipelined RTSP SETUP request or a pipelined aggregate RTSP PLAY request.

The SDP file containing a description of the QoE metrics for the new content may have been sent to client 3 in response to a DESCRIBE request, or may be pre-stored in the client, or may be requested during the switch (not shown in FIG. 8) and sent to the client via RTSP or other means.

In step 906, the new content is then received, and in a step 907, the inherited QoE metrics are measured and reported. Therein, the reporting is continued at the same rate as for the prior media stream or content. When reporting events that happen after the switch is accomplished, the new URLs shall be used instead of the old ones.

In the following, further examples of QoE metric negotiation according to the present invention will be provided, in particular with respect to the first, third and fourth aspect of the present invention. To simplify tracking of the control trackIDs and the associated “rate” of their QoE metrics, these parameters are underlined. Furthermore, all “3GPP-QoE-Metrics” headers are given in bold face.

In the following example, the client agrees to report all of the QoE parameters supported by the server in the SDP file, inter alia the Content_Switch_Time metric according to the first aspect of the present invention.

However, it cannot report them at the “rate” requested by the server in the SDP file. Hence it proposes some changes to the “rate” characteristic associated with some of the QoE parameters (change of rate in trackID=3 from 10 to 15 and change of rate in trackID=5 from 20 to 40). According to the third aspect of the present invention, it indicates these changes in the pipelined RTSP PLAY request. Furthermore, according to the fourth aspect of the present invention, this causes QoE metric negotiation to at least partially take place after an RTSP PLAY request has been launched, since the server is required, even when accepting the client's proposal, to echo the client's proposal in a response to the RTSP PLAY request to acknowledge the client.

| | |
|---|---|
| S->C | RTSP/1.0 200 OK |
| | Cseq: 1 |
| | Content-Type: application/sdp |
| | Content-Base: rtsp://example.com/foo/bar/baz.3gp/ |
| | Content-Length: 800 |
| | Server: PSSR6 Server |
| | v=0 |
| | o=- 3268077682 433392265 IN IP4 63.108.142.6 |
| | s=QoE Enables Session Description Example |
| | e=support@foo.com |
| | c=IN IP4 0.0.0.0 |
| | t=0 0 |
| | a=range:npt=0–83.660000 |
| | a=3GPP-QoE-Metrics:{Initial_Buffering_Duration\|Rebuf |
| | fering_Duration};rate=End |
| | a=3GPP-QoE-Metrics:{Content_Switch_Time};rate=Start |
| | a=control:* |
| | m=video 0 RTP/AVP 96 |
| | b=AS:28 |
| | a=3GPP-QoE-Metrics:{Corruption_Duration\|Decoded_Bytes |
| | };rate=10;range:npt=0–40 |
| | a=control:trackID=3 |
| | a=rtpmap:96 MP4V-ES/1000 |
| | a=range:npt=0–83.666000 |
| | a=fmtp:96profile-level-id=8;config=000001b008000001b |
| | 50900012000 |
| | m=audio 0 RTP/AVP 98 |
| | b=AS:13 |
| | a=3GPP-QoE-Metrics:{Corruption_Duration};rate=20 |
| | a=control:trackID=5 |
| | a=rtpmap:98 AMR/8000 |
| | a=range:npt=0–83.660000 |
| | a=fmtp:98 octet-align=1 |
| | a=maxptime:200 |
| C->S | SETUP rtsp://example.com/foo/bar/baz.3gp/trackID=1 |
| | RTSP/1.0 |
| | Cseq: 2 |
| | ............. |
| C->S | SETUP rtsp://example.com/foo/bar/baz.3gp/trackID=2 |
| | RTSP/1.0 |
| | Cseq: 3 |
| | ............. |
| C->S | PLAY rtsp://example.com/foo/bar/baz.3gp RTSP/1.0 |
| | Cseq: 4 |
| | ............. |
| | 3GPP-QoE-Metrics:url=”rtsp://example.com/foo/bar/baz |
| | .3gp/trackID=3”; |
| | metrics={Corruption_Duration\|Decoded_Bytes};rate=15; |
| | Range:npt=0–40, |
| | url=”rtsp://example.com/foo/bar/baz.3gp/trackID=5”; |
| | metrics={Corruption_Duration}; rate=40; |
| | Range:npt=0–40; |
| | url=”rtsp://example.com/foo/bar/baz.3gp”; |
| | metrics={Initial_Buffering_Duration\|Rebuffering_Duration |
| | };rate=End; |
| | metrics={Content_Switch_Time};rate=Start; |

The server accepts these changes in the “rate” of reporting. Hence it confirms its acceptance in the response to the RTSP PLAY request by echoing the contents of the “3GPP-QoE-Metrics” header. As already stated above, thus the fourth aspect of the present invention is applied here, since QoE metric negotiation at least partially (i.e. with respect to the server-side accepting of parameters) takes place after the RTSP PLAY request.

| | |
|---|---|
| S->C | RTSP/1.0 200 OK |
| | Cseq: 2 |
| | ........... |
| S->C | RTSP/1.0 200 OK |
| | Cseq: 3 |
| | ........... |
| S->C | RTSP/1.0 200 OK |
| | Cseq: 4 |
| | ........... |
| | 3GPP-QoE-Metrics:url=”rtsp://example.com/foo/bar/baz |
| | .3gp/trackID=3”; |
| | metrics={Corruption_Duration\|Decoded_Bytes};rate=15; |
| | Range:npt=0–40, |
| | url=”rtsp://example.com/foo/bar/baz.3gp/trackID=5”; |
| | metrics={Corruption_Duration}; rate=40; |
| | Range:npt=0–40; |
| | url=”rtsp://example.com/foo/bar/baz.3gp”; |
| | metrics={Initial_Buffering_Duration\|Rebuffering_Duration |
| | };rate=End; |
| | metrics={Content_Switch_Time};rate=Start; |

Alternatively, if the server does not agree to the changes that the client proposed, then it continues the negotiation beyond the RTSP PLAY response (also according to the fourth aspect of the present invention).

If the QoE parameters in the RTSP PLAY response are identical to the ones proposed by the client in the RTSP PLAY request, the client shall stop the negotiation.

Otherwise, it shall continue the negotiation using the RTSP OPTIONS or RTSP SET_PARAMETER requests until the client and server reach an agreement.

The following example is a continuation of the above example (also according to the fourth aspect of the present invention), where the server agrees with the client's proposal in all metrics and associated values except the “rate” for the QoE metric “Decoded_Bytes”. The server proposes to send the Decoded_Bytes at “rate“=5. But the client cannot send them so frequently, hence it sends the maximum rate it supports (“rate”=10) in the next round of negotiation. It excludes the already agreed QoE metrics from the negotiation. It re-proposes the new values for the remaining QoE metrics using the RTSP OPTIONS request. The server eventually agrees to this value.

| | |
|---|---|
| S->C | RTSP/1.0 200 OK |
| | Cseq: 4 |
| | ......... |
| | 3GPP-QoE-Metrics:url=”rtsp://example.com/foo/bar/baz |
| | .3gp/trackID=3”; |
| | metrics={Corruption_Duration };rate=15; |
| | Range:npt=0–40, |
| | metrics={Decoded_Bytes };rate=5; Range:npt=0–40, |
| | url=”rtsp://example.com/foo/bar/baz.3gp/trackID=5”; |
| | metrics={Corruption_Duration}; rate=40; |
| | Range:npt=0–40; |
| | url=”rtsp://example.com/foo/bar/baz.3gp”; |
| | metrics={Initial_Buffering_Duration\|Rebuffering_Duration |
| | };rate=End; |
| | metrics={Content_Switch_Time};rate=Start; |
| C->S | OPTIONS rtsp://example.com/foo/bar/baz.3gp/trackID=5 |
| | RTSP/1.0 |
| | Cseq: 5 |
| | 3GPP-QoE-Metrics:url=”rtsp://example.com/foo/bar/baz |
| | .3gp/trackID=3”; |
| | metrics={ Decoded_Bytes };rate=10; Range:npt=0–40, |
| | ......... |
| S->C | RTSP/1.0 200 OK |
| | Cseq: 5 |
| | 3GPP-QoE-Metrics:url=”rtsp://example.com/foo/bar/baz |
| | .3gp/trackID=3”; |
| | metrics={ Decoded_Bytes };rate=10; Range:npt=0–40, |

In the above-presented detailed description of the invention, exemplary embodiments of the present invention have been described in the context of a Third Generation Partnership Project (3GPP) Packet-switched Streaming Service (PSS) system.

It is understood that the present invention is not limited to deployment in the 3GPP PSS system, but may equally well be deployed in all other types of transmission systems where quality reporting is applicable, for instance in the context of conversational systems (e.g. video-telephony), where information between two or more clients is exchanged via a network, and where metrics may for instance be captured by a network element, such as for instance a Session Initiation Protocol (SIP) proxy.

A further exemplary deployment scenario for the present invention is the Multimedia Broadcast/Multicast Service (MBMS), where the switch time metric may also be used and conveyed to the server via the Extended Markup Language (XML), the Hypertext Transfer Protocol (HTTP) or other means. The content switch time metric may also mean the switching between MBMS and unicast PSS, or vice-versa. If the content is the same the content switch time may measure the time it takes to switch from one network to another network. If the content is different, the content switch time may measure the time it takes to switch from one network to another network plus the already defined content switch time according to the first aspect of the present invention.

It is also readily understood that the QoE metrics do not necessarily have to be carried by RTSP and SDP. Equally well, other protocols could be used to carry the QoE metrics, for instance the SIP, the XML, the HTTP or the Short Message Service (SMS), to name but a few possibilities.

The invention has been described above by means of exemplary embodiments. It should be noted that there are alternative ways and variations which are obvious to a person skilled in the art and can be implemented without deviating from the scope and spirit of the appended claims.

Furthermore, it is readily clear for a skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. The computer software may be stored in a variety of storage media of electric, magnetic, electromagnetic or optic type and may be read and executed by a processor, such as for instance a microprocessor. To this end, the processor and the storage medium may be coupled to interchange information, or the storage medium may be included in the processor.

Finally, the embodiments of the present invention shall also be understood to be disclosed in all possible combinations with each other. March 16, 2007

What is claimed is:

1. A client-side method, comprising:
measuring a quality of a transmission session according to one or more metrics to be reported to a server, wherein said one or more metrics comprise a content switch time metric that is related to a time it takes to switch between contents in said transmission session.

2. The method of claim 1, wherein said content switch time metric is defined as one of a time from an instant at which a new content on a client is selected to an instant at which a first media frame of said new content is played back, and a time from an instant a switch request is sent from a client to a server to an instant a first media packet of said new content is received at said client.

3. The method of claim 1, wherein said content switch time metric can be negotiated to be reported immediately.

4. The method of claim 1, wherein said content switch time metric is a quality of experience metric of the third generation partnership project packet-switched streaming service.

5. A computer-readable medium having a computer program stored thereon, the computer program comprising instructions operable to cause a processor to perform the method of claim 1.

6. A client-side device, comprising:
a processing unit configured to measure a quality of a transmission session according to one or more metrics to be reported to a server, wherein said one or more metrics comprise a content switch time metric that is related to a time it takes to switch between contents in said transmission session.

7. The device of claim 6, wherein said content switch time metric is a quality of experience metric of the third generation partnership project packet-switched streaming service.

8. A server-side method, comprising:
processing one or more metrics according to which a client reports a quality of a transmission session, wherein said one or more metrics comprise a content switch time metric that is related to a time it takes to switch between contents in said transmission session.

9. The method of claim 8, wherein said content switch time metric is a quality of experience metric of the third generation partnership project packet-switched streaming service.

10. A computer-readable medium having a computer program stored thereon, the computer program comprising instructions operable to cause a processor to perform the method of claim 8.

11. A server-side device, comprising:
a processing unit configured to process one or more metrics according to which a client reports a quality of a transmission session, wherein said one or more metrics comprise a content switch time metric that is related to a time it takes to switch between contents in said transmission session.

12. The device of claim 11, wherein said content switch time metric is a quality of experience metric of the third generation partnership project packet-switched streaming service.

13. A system, comprising a client-side device according to claim 6 and a server-side device according to claim 11.

14. A method, comprising:
accepting at a client, in case a switching of a previous content to a new content with common media types between said previous and said new content occurs in a transmission session, for reporting a quality of a transmission of said new content, all of the one or more metrics that have already been negotiated between a client and a server for reporting a quality of a transmission of said common media types of said previous content.

15. The method of claim 14, wherein said client accepts said metrics in a request for playback of said new content.

16. The method of claim 14, wherein said metrics are quality of experience metrics according to the third generation partnership project packet-switched streaming service.

17. A computer-readable medium having a computer program stored thereon, the computer program comprising instructions operable to cause a processor to perform the method of claim 14.

18. A device, comprising:
a processing unit configured to accept, in case a switching of a previous content to a new content with common media types between said previous and said new content occurs in a transmission session, for reporting a quality of a transmission of said new content, all of the one or more metrics that have already been negotiated between a client and a server for reporting a quality of a transmission of said common media types of said previous content.

19. The device of claim 18, wherein said content switch time metric is a quality of experience metric of the third generation partnership project packet-switched streaming service.

20. A system, comprising a server and a client, said client comprising a device according to claim 19.

21. A protocol, comprising:
a rule allowing or prescribing that, in case a switching of a previous content to a new content with common media types between said previous and said new content occurs in a transmission session, all of the one or more metrics that have already been negotiated between a client and a server for reporting a quality of a transmission of said previous content are accepted by said client for reporting a quality of a transmission of said common media types of said new content.

22. A method, comprising:
negotiating at least one metric for reporting a quality of a transmission session, wherein client-side negotiating is not started before a launch of a plurality of pipelined requests comprising at least one request for setup of a media transmission in said transmission session and a request for playback of content in said transmission session.

23. The method of claim 22, wherein said negotiating at least partially takes place after said requested for playback of said content.

24. The method of claim 22, wherein said metrics are quality of experience metrics according to the third generation partnership project packet-switched streaming service.

25. A computer-readable medium having a computer program stored thereon, the computer program comprising instructions operable to cause a processor to perform the method of claim 22.

26. A client-side device, comprising:
a processing unit configured to negotiate at least one metric for reporting a quality of a transmission session, wherein client-side negotiating is not started before a launch of a plurality of pipelined requests comprising at least one request for setup of a media transmission in said transmission session and a request for playback of content in said transmission session.

27. The device of claim 26, wherein said content switch time metric is a quality of experience metric of the third generation partnership project packet-switched streaming service.

28. A system, comprising a server and a client, said client comprising a device according to claim 26.

29. A protocol, comprising:
a rule prescribing that client-side negotiating of at least one metric for reporting a quality of a transmission session shall not start before a launch of a plurality of pipelined requests comprising at least one request for setup of a media transmission in said transmission session and a request for playback of content in said transmission session.

30. A method, comprising:
negotiating at least one metric for reporting a quality of a transmission session, wherein said negotiating at least partially takes place after a client has requested playback of content within said transmission session.

31. The method of claim 30, wherein, in case a switching of a previous content to a new content comprising at least one different or additional media stream as compared to the media streams in the previous content occurs, said client starts negotiating said at least one metric for said at least one media stream by inserting information related to said at least one metric into one of a request for setup of said at least one media stream in said transmission session and a request for playback of said new content in said transmission session, both of which requests are pipelined and sent from said client to said server.

32. The method of claim 30, wherein said metrics are quality of experience metrics of the third generation partnership project packet-switched streaming service.

33. A computer-readable medium having a computer program stored thereon, the computer program comprising instructions operable to cause a processor to perform the method of claim 30.

34. A client-side device, comprising:
a processing unit configured to negotiate at least one metric for reporting a quality of a transmission session, wherein said negotiating takes place after a client has already requested playback of content within said transmission session.

35. The device of claim 34, wherein said content switch time metric is a quality of experience metric of the third generation partnership project packet-switched streaming service.

36. A server-side device, comprising:
a processing unit configured to negotiate at least one metric used by a client to report a quality of a transmission session, wherein said negotiating at least partially takes place after said client has requested playback of content within said transmission session.

37. The device of claim 36, wherein said content switch time metric is a quality of experience metric of the third generation partnership project packet-switched streaming service.

38. A system, comprising a client comprising a client -side device according to claim 34 and a server comprising a server-side device according to claim 36.

39. A protocol, comprising:
a rule allowing that at least one metric for reporting a quality of a transmission session is at least partially negotiated after a client has requested playback of content within said transmission session.

40. A method, comprising:
inheriting, in case a switching of a previous content to a new content occurs within a transmission session, at least one metric negotiated between a client and a server for reporting a quality of a transmission of said previous content.

41. The method of claim 40, wherein a reporting rate for the previous content is the same as a reporting rate for said new content.

42. The method of claim 40, wherein it is prescribed for the client in one of an SDP file and a request prior to or during said switching of content that said at least one metric shall be inherited.

43. The method of claim 40, wherein said metrics are quality of experience metrics according to the third generation partnership project packet-switched streaming service.

44. A computer-readable medium having a computer program stored thereon, the computer program comprising instructions operable to cause a processor to perform the method of claim 40.

45. A device, comprising:
a processing unit configured to inherit, in case a switching of a previous content to a new content occurs within a transmission session, at least one metric negotiated between a client and a server for reporting a quality of a transmission of said previous content.

46. The device of claim 45, wherein said content switch time metric is a quality of experience metric of the third generation partnership project packet-switched streaming service.

47. A system, comprising a server and a client, said client comprising a device according to claim 45.

48. A protocol, comprising:
a rule allowing or prescribing that, in case a switching of a previous content to a new content occurs within a transmission session, at least one metric negotiated between a client and a server for reporting a quality of a transmission of said previous content is inherited.
